(19) United States
(12) Patent Application Publication
(10) Pub. No.: US 2008/0314714 A1
(43) Pub. Date: Dec. 25, 2008

(54) Stabilizer for a Motor Vehicle

(76) Inventors: Stefan Beetz, Barnin (DE); Winfried Kruger, Parchim (DE); Torsten Baustian, Crivitz (DE)

Correspondence Address: MCGLEW & TUTTLE, PC, P.O. BOX 9227, SCARBOROUGH STATION, SCARBOROUGH, NY, 10510-9227, US

(21) Appl. No.: 10/596,342

(22) PCT Filed: Dec. 8, 2004
(86) PCT No.: PCT/DE2004/002693

§ 371 Date: Sep. 8, 2008

(30) Foreign Application Priority Data
Dec. 12, 2003 (DE) 103 58 762.4

(51) Int. Cl. F16D 11/14

(52) U.S. Cl. 192/108

(57) ABSTRACT

One-part stabilizers are designed for road traffic only or for off-road travel only. Two-part stabilizers with a shiftable clutch have drawbacks in terms of quality and safety. A clutch is therefore presented, whose radial carriers (14, 16) are located on the same plane and which are fixed without clearance via a shiftable and axially displaceable locking piston (17) with locking elements (23) or are released over a predetermined pivot angle.

### CROSS REFERENCE TO RELATED APPLICATIONS

This application is a United States National Phase application of International Application PCT/DE 2004/002693 and claims the benefit of priority under 35 U.S.C. § 119 of German Patent Application DE 103 58 762.4 filed Dec. 12, 2003, the entire contents of which are incorporated herein by reference.

### FIELD OF THE INVENTION

The present invention pertains to a stabilizer with stabilizer parts, which are connected to the wheel suspension of a wheel, on the one hand, and with the vehicle body via a mounting point, on the other hand, and both the stabilizer parts can be connected to one another via a shiftable and positive-locking clutch.

### BACKGROUND OF THE INVENTION

Such stabilizers are used in automotive engineering.

In principle, a stabilizer, which operates according to the principle of the torsion bar, extends in parallel to the axle and is fastened at both ends of a wheel suspension, is associated with each axle of a motor vehicle. These stabilizers have the task of preventing or weakening the transmission of the rolling motions that are caused by the road conditions and originate from the wheels to the vehicle. Such rolling motions are generated mainly in road curves or in case of unevenness of the road, for example, potholes or ruts. There are one-part stabilizers adapted to certain fields of use, but they respond either too softly or too harshly to different loads and lack a sufficient range of torsion for some applications. This has a disadvantageous effect on driving comfort.

Two-part stabilizers, which are connected to one another by a clutch, are therefore increasingly used for special applications. The two parts of the stabilizer are connected to one another directly in the coupled state in such a way that they rotate in unison, so that the action of a one-part stabilizer is thus achieved. In the uncoupled state, an additional free angle of rotation is set between a mechanical stop for one direction of rotation and a stop for the other direction of rotation. A vehicle equipped with such a stabilizer that can be coupled can be used under normal road conditions and abnormal road conditions alike.

Such a two-part stabilizer with a clutch is described in DE 199 23 100 C1. The corresponding clutch comprises a cylindrical housing, which is connected to one of the two stabilizer halves in such a way that they rotate in unison. A shaft, which projects from the housing and is connected to the second stabilizer half in such a way that they rotate in unison, is mounted rotatably in the cylindrical housing. The housing has a stationary and inwardly directed carrier, and the shaft located inside carries, in the same radial plane, an outwardly directed, second carrier, which rotates in unison. Corresponding free spaces, with which two claws of a locking piston mesh, are located between the two carriers. This locking piston is axially displaceable and is loaded by a compression spring in the closing direction and by a hydraulic force in the opposite direction. Both the carriers and the claws are mutually fitting force transmission surfaces, which are axially conical and radially flat.

It has now been found that the carriers of the two stabilizer parts and the claws of the locking piston are jammed with one another under the loads of the compression spring and the torsional forces, so that unusually strong hydraulic adjusting forces are necessary for uncoupling. This can be attributed to the fact that force components that load the two stabilizer halves, on the one hand, and the claws of the locking piston, on the other hand, radially in opposite directions, occur in the areas of the force transmission surfaces. This leads to widening or narrowing of the carriers and the locking claws, as a result of which the position of the conical surfaces located opposite each other will change as well. After elimination of the external loads, the carriers and the claws seek, due to their internal stresses, to assume their original shapes, and the carriers and the claws are wedged in one another because the conical surfaces no longer fit each other.

### SUMMARY OF THE INVENTION

The basic object of the present invention is therefore to develop a stabilizer of this type, in which the positions of the mutually corresponding and force-transmitting conical surfaces of the clutch in relation to one another remain unchanged.

According to the invention, a stabilizer for a motor vehicle is provided comprising two stabilizer parts, which are connected to the wheel suspension of a wheel, on the one hand, and with the vehicle body via a mounting point, on the other hand. Both of the stabilizer parts can be connected to one another via a shiftable and positive-locking clutch. The clutch comprises at least one radial carrier of one stabilizer part, at least one radial carrier of the other stabilizer part and an axially displaceable locking piston with locking claws. The locking claws and the carriers have conical surfaces, which fit each other and are designed as force transmission surfaces. The conical surfaces of the radial carriers and the conical surfaces of the locking claws have an arched cross section over the entire force transmission area. The arch is designed as a concave arch, on the one hand, and as a convex arch, on the other hand.

Jamming of the torque-transmitting elements is ruled out in the new clutch. This has an advantageous effect on the shifting function of the clutch and also requires only very weak adjusting forces. It is advantageous in this connection if the arches of the conical surfaces of the radial carriers and of the locking claws have an equal radius, because the load-bearing capacity and the slidability of the mutually corresponding conical surfaces improve.

The new clutch with its arched contour has special technical effects. Thus, the arch of the force-transmitting conical surfaces causes the circumferential forces prevailing in the contact area of the conical surfaces located opposite each other to develop different force components along the arched conical surface. Thus, the radial force components are greater at the inner and outer ends of the arch than in the area located in between. However, since these radial force components are directed opposite each other, they largely offset each other, so that there are, in toto, only small radial force components, which bend the free ends of the radial carriers and of the locking claws either to the outside or to the inside. This considerably reduces the risk of jamming.

If radial force components still act on the radial carriers and the locking claws and change their positions in relation to one another, the mutually corresponding conical surfaces act like the sliding surfaces of a ball bearing. Jamming of the corresponding carriers and locking claws is therefore also ruled out. The present invention shall be explained in greater detail below on the basis of an exemplary embodiment.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a simplified view of a stabilizer that can be coupled;

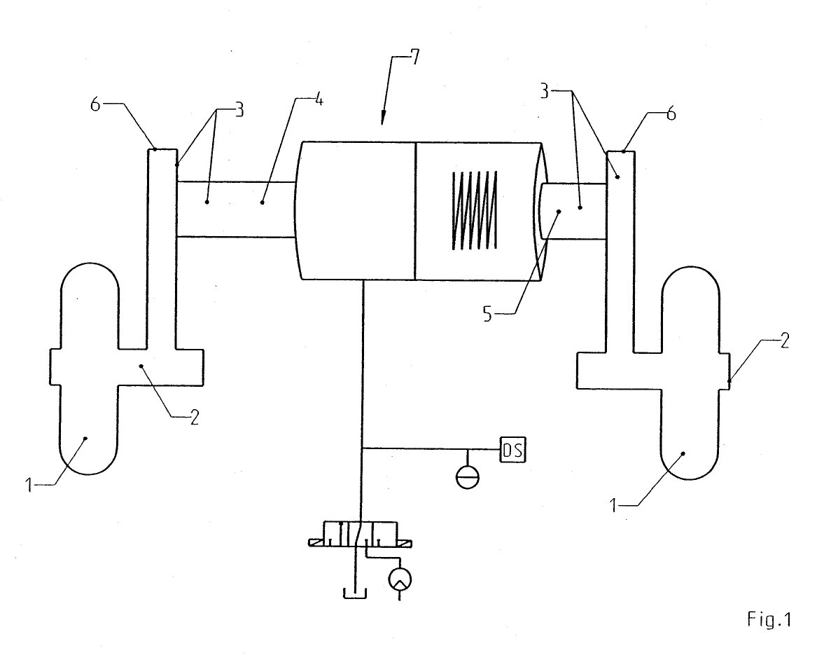

FIG. 2 is a simplified sectional view of the clutch;

FIG. 3 is the clutch in the locked state;

FIG. 4 is the locking piston;

FIG. 5 is the radial carrier of one stabilizer part;

FIG. 6 is the radial carrier of the other stabilizer part; and

FIG. 7 is a partial view of the engaged clutch.

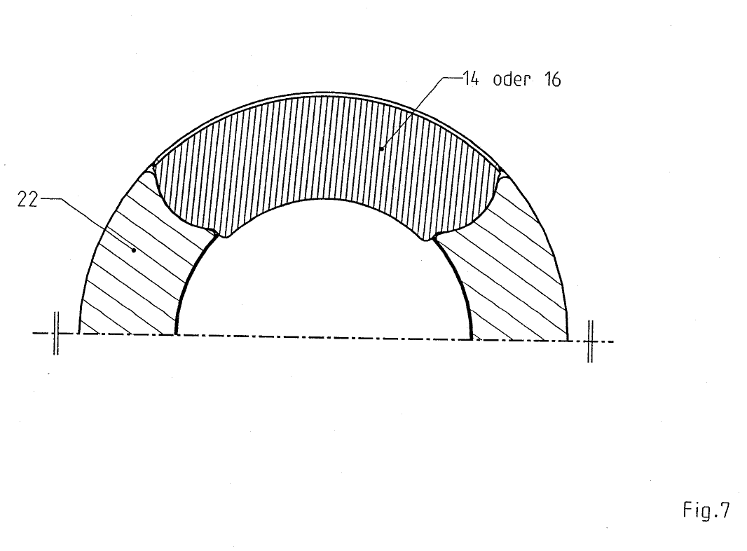

### DESCRIPTION OF THE PREFERRED EMBODIMENTS

Referring to the drawings in particular, each axle of a motor vehicle comprises, in principle, the two wheels 1 and an axle 2 carrying the two wheels 1. A divided stabilizer 3 with its two stabilizer parts 4 and 5 is located in parallel to the axle 2, each stabilizer part 4, 5 being connected to a wheel suspension, not shown, of the corresponding wheel 1 and, on the other hand, via a mounting point 6, with the vehicle chassis. A clutch 7, which connects the two stabilizer parts 4, 5 to one another into a continuous stabilizer 3 or separates them from one another, is arranged between the two stabilizer parts 4 and 5. The dimensioning and the properties of the material of the connected stabilizer 3 are selected such as to absorb the torsional forces introduced via the wheels 1 and to build up corresponding opposing forces. Thus, these forces are not transmitted to the vehicle body or are at least attenuated.

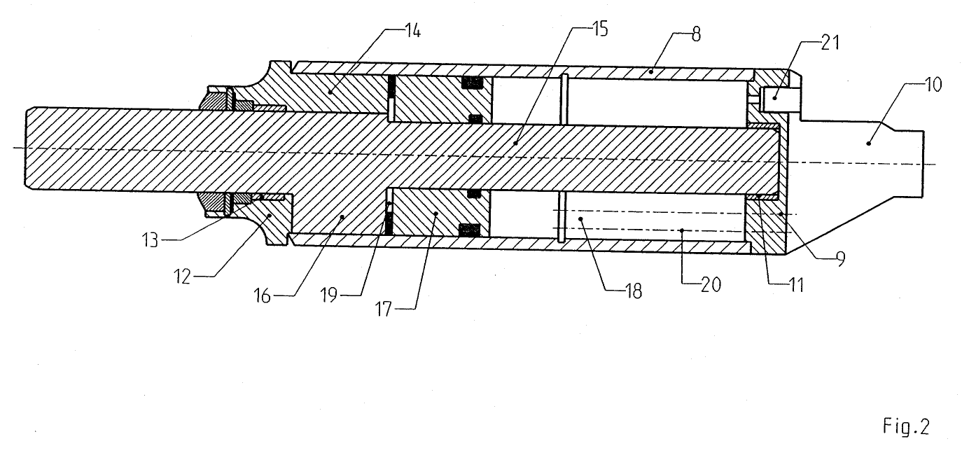

The clutch 7 can be shifted axially and has a positive-locking design. The clutch 7 comprises for this purpose, according to FIG. 2, a cylindrical housing 8 with a closed bottom 9, which is joined by a connection pin 10 for one of the two stabilizer parts 4, 5. A mounting point 11 for a hinge is located on the inner side of the bottom 9. Opposite the bottom 9, the housing 8 is closed, rotating in unison, with a cover 12, which is equipped with a continuous bearing bore 13 for another hinge, and with a radial carrier 14, which protrudes into the interior of the cylindrical housing 8. The radial carrier 14 is located in the radial space between the continuous bearing bore 13 and the inner wall of the cylindrical housing 8.

Furthermore, a shaft 15, which passes through the interior of the cylindrical housing 8 and is mounted rotatably in the mounting point 11 in the bottom 9 of the housing 8, on the one hand, and in the bearing bore 13 in the cover 12 of the housing 8, on the other hand, is fitted into the housing 8. The shaft 15 is connected to the other stabilizer part 4, 5 in such a way that they rotate in unison.

Another radial carrier 16, which is arranged in the housing 8 and designed in the same manner as the radial carrier 14, is located on the shaft 15. The radial carrier 14 at the cylindrical housing 8 and the radial carrier 16 on the shaft 15 are thus located on a common radial plane, as a result of which both radial carriers 14 and 16 are pivotable in relation to one another to a limited extent only.

Furthermore, a locking piston 17, to which hydraulic pressure can be admitted, is axially displaceable on the shaft 15 and is guided in a radially rotatable manner and which divides the interior space of the cylindrical housing 8 into a compression spring space 18 on the bottom side and into a pressure space 19 on the cover side, is located in the interior of the cylindrical housing 8. A compression spring 20, which is supported at the bottom 9 of the housing 8 and loads the locking piston 17, is inserted into the compression spring space 18. The compression spring space 18 is connected to a hydraulic tank via an overflow oil connection 21. By contrast, the pressure space 19 is connected to a hydraulic compressed oil supply unit via a compressed oil connection, not shown.

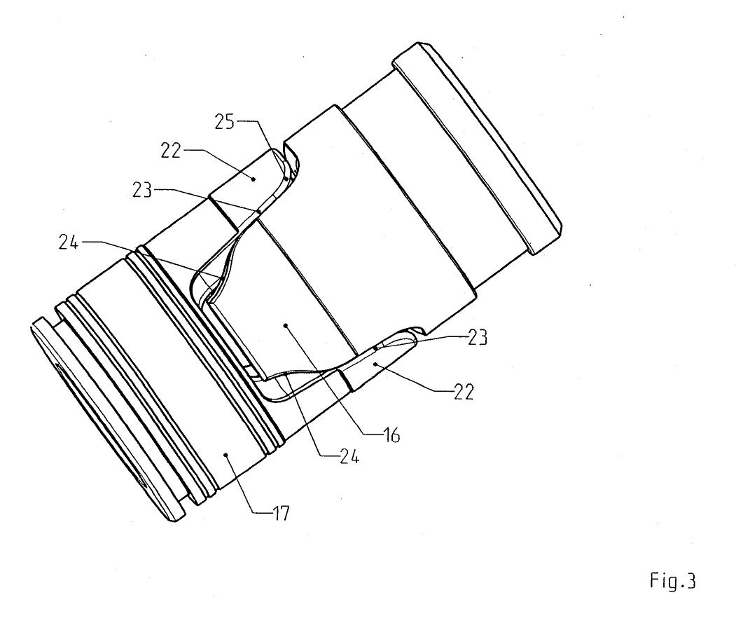

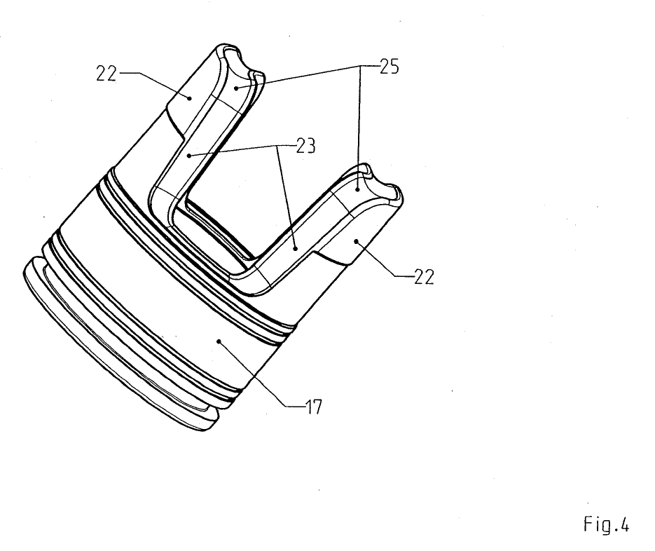

As is shown in FIGS. 3 and 4, two locking claws 22, which are located, in the same manner as the two radial carriers 14 and 16, in the radial free space between the shaft 15 and the inner wall of the housing 8 and which are both arranged opposite each other, i.e., offset by 180° in relation to one another, are formed on the cover side of the locking piston 17. The shape and the dimensions of the two locking claws 22 are coordinated in a special manner with the shapes and dimensions of the two radial carriers 14 and 16. Thus, the two gaps between the two radial carriers 14 and 16 are thus filled out without a clearance. Furthermore, the locking piston 17 is equipped with a stroke limitation means, which prevents the two radial carriers 14, 16 and the two locking claws 22 from becoming disengaged in the other end position of the locking piston 17. Consequently, a positive length coverage of the radial carriers 14, 16 and the locking claws 22 of the locking piston 17 continues to be present in this end position.

The contact surfaces of the two carriers 14, 16 and of the two locking claws 22, which said surfaces are located opposite each other and communicate with one another, are designed as force transmission surfaces. The two carriers 14, 16 and the two locking claws 22 have for this purpose a conical surface 23 each with a smaller angle, which are in contact with one another without a clearance in the coupled state. The conicity of the conical surfaces 23 with the smaller angle is selected to be so small that the axial force component of a radial force introduced to the stabilizer 3 from the outside does not exceed the spring force of the compression spring 22. In addition, the two carriers 14, 16 have a conical surface 24 with a larger angle at their free end and the two locking claws 22 have a conical surface 25 with a larger angle at their free ends, which conical surfaces form a radial clearance with one another in the uncoupled state. The two stabilizer halves 4, 5 are freely rotatable in relation to one another within this free space.

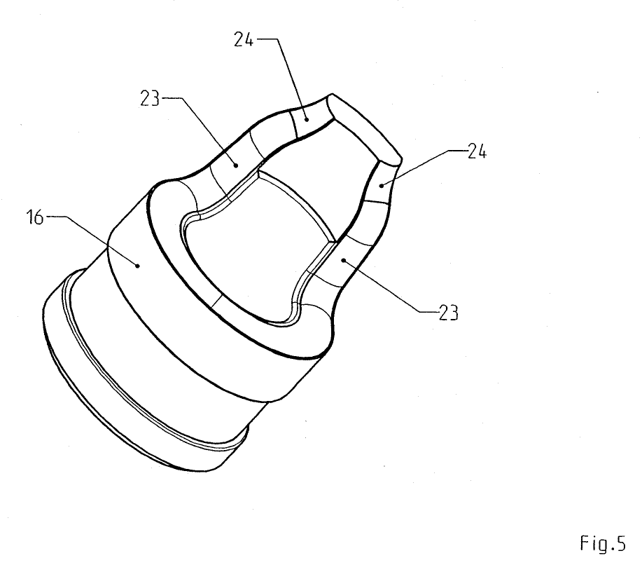

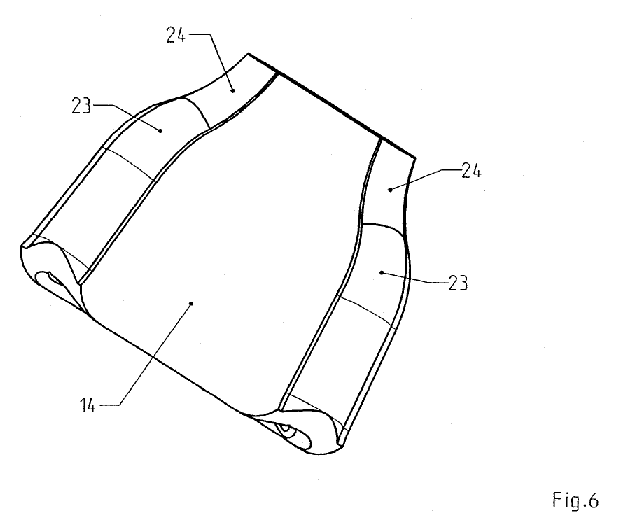

The force transmission surfaces composed of the conical surfaces 23, 24, 25 at the two carriers 14, 16 and at the two locking claws 22 have an arched contour in their cross section. Thus, FIG. 4 shows conical surfaces 23, 25 at the locking claws 22 with a concave arch that extends over the entire force transmission area and has a uniform design. By contrast, the conical surfaces 23, 24 of the two radial carriers 14, 16 according to FIGS. 5 and 6 are provided with a convex arch over their entire force transmission area. The dimensions and the geometries of the concave arch of the force transmission surfaces of the two locking claws 22 and of the convex arch of the force transmission surfaces of the two carriers 14, 16 are adapted to one another.

Under normal road conditions, for example, during road traffic, the pressure space 19 in the cylindrical housing 8 is kept pressureless, so that the compression spring 20 loads the locking piston 17 and displaces it in the direction of the radial carriers 14, 16. Lateral contact develops between the radial carriers 14, 16 and the two locking claws 22. As a result, the radial carriers 14, 16 and the rotatable locking piston 17 are centered, so that the two locking claws 22 penetrate into the intermediate spaces between the two radial carriers 14, 16 to the extent that the conical surfaces 23 with smaller angle will mutually come into contact with one another. The locking piston 17 is held in this position by the force of the compression spring 20 over the entire loading area. The stabilizer parts 4, 5 thus coupled behave now as a one-part stabilizer.

Under poor road conditions, which occur, for example, off the road, the torsion range of the coupled stabilizer 3 is no longer sufficient to compensate the rolling motions of the wheels. By actuating a preferably hydraulic pressure supply unit, the pressure space 19 of the clutch is pressurized in such cases, so that the locking piston 17 separates from the contact area of the conical surfaces 23 with the smaller angle against the force of the compression spring 20 and is displaced into its end position defined by the stroke limitation means. By maintaining the hydraulic pressure in the pressure space 19, the locking piston 17 is held in this position. The two stabilizer parts 4, 5 are thus separated, but they remain in axial overlap in the area of the conical surfaces 24, 25 with a larger angle. In case of different loads on the two wheels of one axle, one of the two radial carriers 14, 16 in the area of the conical surfaces 24 with the larger angle comes into contact in the area of the conical surface 25 with a larger angle of one of the locking claws 22 and rotates until it is supported on the conical surface 24 with the larger angle of the other of the two carriers 14, 16. The two stabilizer parts 4, 5 are again connected to one another in this coupled state, so that they are capable of absorbing torsional forces in the same direction of rotation.

While specific embodiments of the invention have been shown and described in detail to illustrate the application of the principles of the invention, it will be understood that the invention may be embodied otherwise without departing from such principles.

1. A stabilizer for a motor vehicle, comprising two stabilizer parts (4, 5), which are connected to the wheel suspension of a wheel (1), on the one hand, and with the vehicle body via a mounting point (6), on the other hand, and both said stabilizer parts (4, 5) can be connected to one another via a shiftable and positive-locking clutch (7) comprising at least one radial carrier (14, 16) of one said stabilizer part (4, 5), at least one radial carrier (14, 16) of the other stabilizer part (14, 16) and an, axially displaceable locking piston (17) with locking claws (22), and the locking claws (22) and the carriers (14, 16) have said conical surfaces (23, 24, 25), which fit each other and are designed as force transmission surfaces,
characterized in that
the conical surfaces (23, 24) of the radial carriers (14, 16) and the conical surfaces (23, 25) of the locking claws (22) have an arched cross section over the entire force transmission area, the arch being designed as a concave arch, on the one hand, and as a convex arch, on the other hand.

2. A stabilizer in accordance with claim 1,
characterized in that the conical surfaces (23, 24) of the radial carriers (14, 16) are convex and the conical surfaces (23, 25) of the locking claws (22) are concave.

3. A stabilizer in accordance with claim 1,
characterized in that the radii of the concave and convex arches are equal.
